(19) United States
(12) Patent Application Publication
(10) Pub. No.: US 2022/0407081 A1
(43) Pub. Date: Dec. 22, 2022

(54) ELECTROCHEMICAL APPARATUS AND ELECTRONIC APPARATUS

(71) Applicant: Ningde Amperex Technology Limited, Ningde (CN)

(72) Inventors: Shan ZHU, Ningde (CN); Ting GUAN, Ningde (CN); Fei WU, Ningde (CN)

(73) Assignee: Ningde Amperex Technology Limited, Ningde (CN)

(21) Appl. No.: 17/845,555

(22) Filed: Jun. 21, 2022

(30) Foreign Application Priority Data
Jun. 21, 2021 (CN) 202110687683.2

(51) Int. Cl. H01M 4/66; H01M 10/0525; H01M 4/62

(52) U.S. Cl. CPC H01M 4/667; H01M 10/0525; H01M 4/623; H01M 4/625

(57) ABSTRACT

An electrochemical apparatus includes an electrode plate including a current collector, a first coating layer, and a second coating layer. The first coating layer is provided between the current collector and the second coating layer. The second coating layer includes a first active material. R2*d/D<R1, wherein R1 refers to a resistance of the first coating layer, R2 refers to a resistance of the second coating layer, d refers to a thickness of the first coating layer, D refers to a thickness of the second coating layer, R2 and R1 are measured in ohms, and D and d are measured in microns.

### CROSS REFERENCE TO RELATED APPLICATION

This application claims priority to the Chinese Patent Application Ser. No. 202110687683.2, filed on Jun. 21, 2021, the content of which is incorporated herein by reference in their entirety.

### TECHNICAL FIELD

This application relates to the field of electrochemical energy storage, and in particular, to an electrochemical apparatus and an electronic apparatus.

### BACKGROUND

As electrochemical energy storage technologies develop, increasingly high requirements are imposed on safety performance and fast-charging performance of electrochemical apparatuses (for example, lithium-ion batteries). However, the safety performance and fast-charging performance of the electrochemical apparatuses often contradict each other to some extent. How to ensure both the safety performance and fast-charging performance of the electrochemical apparatuses is a problem to be resolved.

### SUMMARY

Embodiments of this application provide an electrochemical apparatus, where the electrochemical apparatus includes an electrode plate, where the electrode plate includes a current collector, a first coating layer, and a second coating layer. The first coating layer is provided between the current collector and the second coating layer. The second coating layer includes a first active material. A resistance of the first coating layer is R1, a resistance of the second coating layer is R2, a thickness of the first coating layer is d, and a thickness of the second coating layer is D, where R2*d/D<R1 and 1.1≤R1/(R2*d/D)≤8. The electrochemical apparatus satisfies the following characteristics: in a charging process, being constant-current charged to a first voltage with a first current, being constant-current charged to a second voltage higher than the first voltage with a second current lower than the first current, and then being constant-voltage charged to a cut-off current.

In some embodiments, the thickness of the first coating layer is greater than 0.5 μm and less than 8 μm. In some embodiments, the thickness of the second coating layer is greater than 20 μm and less than 200 μm.

In some embodiments, the electrode plate is a positive electrode plate, and the first coating layer includes a first binder and at least one of conductive carbon, ceramic, or a second active material, where a conductivity of the second active material is lower than a conductivity of the first active material. In some embodiments, when the first coating layer includes the second active material, a mass percentage of the first binder in the first coating layer ranges from 1% to 10%; or when the first coating layer does not include the second active material, a mass percentage of the first binder in the first coating layer ranges from 30% to 80%. In some embodiments, the first binder includes at least one of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, or polyvinyl alcohol. In some embodiments, the conductive carbon includes at least one of conductive carbon black, carbon nanotube, conductive graphite, graphene, acetylene black, or carbon nanofiber.

In some embodiments, the electrode plate is a negative electrode plate, and the first coating layer includes a second binder and at least one of conductive carbon or ceramic. In some embodiments, a mass percentage of the second binder in the first coating layer ranges from 30% to 80%. In some embodiments, the second binder includes at least one of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, or polyvinyl alcohol. In some embodiments, the conductive carbon includes at least one of conductive carbon black, carbon nanotube, conductive graphite, graphene, acetylene black, or carbon nanofiber.

In some embodiments, the first voltage is a voltage when a state of charge of the electrochemical apparatus is 100%, a difference between the second voltage and the first voltage is less than or equal to 500 mV, and a ratio of the second current to the first current is greater than 0.5 and less than 1. In some embodiments, a cut-off current is greater than 0.1 C and less than 0.6 C.

Some embodiments of this application provide an electronic apparatus, including the electrochemical apparatus according to any one of the foregoing aspects.

In the embodiments of this application, R2*d/D<R1 and 1.1≤R1/(R2*d/D)≤8, so that overall impedance of the electrode plate can be increased and short circuit can be avoided, thereby improving safety performance of the electrochemical apparatus. In addition, a new charging method is used, that is, the electrochemical apparatus is constant-current charged to the second voltage higher than the first voltage with the second current less than the first current, and then constant-voltage charged to a cut-off current, which helps improve a charging speed of the electrochemical apparatus. Therefore, the technical solution of this application can implement faster charging while ensuring safety performance of the electrochemical apparatus, thereby improving fast-charging performance.

### BRIEF DESCRIPTION OF DRAWINGS

FIG. 1 is a cross-sectional view of an electrode plate 10 of an electrochemical apparatus that is taken along a plane defined by width and thickness directions of the electrode plate according to some embodiments of this application; and

FIG. 2 and FIG. 3 illustrate a difference between a charging process in this application and conventional constant-current and constant-voltage charging processes.

### DETAILED DESCRIPTION

The following embodiments may help persons skilled in the art to understand this application more comprehensively, but impose no limitation on this application in any manner.

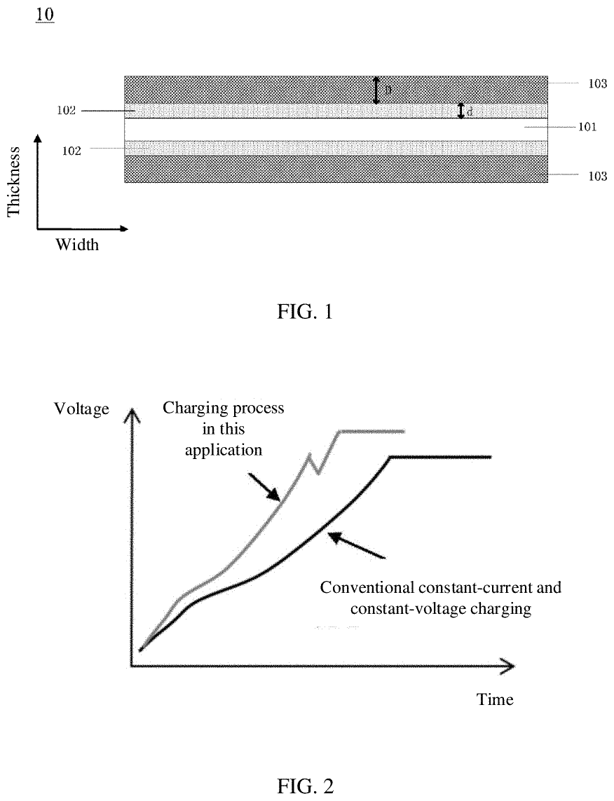

FIG. 1 is a cross-sectional view of an electrode plate 10 of an electrochemical apparatus that is taken along a plane defined by width and thickness directions of the electrode plate according to some embodiments of this application. An embodiment of this application provides an electrochemical apparatus. The electrochemical apparatus includes an electrode plate 10 shown in FIG. 1, where the electrode plate 10 includes a current collector 101, a first coating layer 102, and a second coating layer 103, and the first coating layer 102 is provided between the current collector 101 and the second coating layer 103. It should be understood that although the first coating layer 102 and the second coating layer 103 are located on two sides of the current collector 101 in FIG. 1, this is only an example, and the first coating layer 102 and/or the second coating layer 103 may be located on only one side of the current collector 101.

In some embodiments, the second coating layer 103 includes a first active material. In this application, the active material is a material capable of implementing reversible deintercalation and intercalation of lithium ions. In some embodiments, a resistance of the first coating layer 102 is R1, a resistance of the second coating layer 103 is R2, a thickness of the first coating layer 102 is d, and a thickness of the second coating layer 103 is D, where R2*d/D<R1 and 1.1≤R1/(R2*d/D)≤8. R2*d/D<R1 indicates that a resistance per unit thickness of the first coating layer 102 is greater than a resistance per unit thickness of the second coating layer 103. In other words, presence of the first coating layer 102 can increase overall impedance of the electrode plate, thereby reducing heat generation due to short circuit, preventing thermal runaway, and improving safety performance of the electrochemical apparatus. R2 and R1 are measured in the same unit, namely, ohms. D and d are measured in the same unit, namely, microns.

There are mainly the following two methods for testing a resistance of the foregoing coating layers, but this is only used as an example, and other proper test methods may also be used. The first test method is a film resistance test method: An electrode plate including the first coating layer 102 and the second coating layer 103 are selected, thickness D′ of the electrode plate is measured, film resistance R′ is directly measured by using a film resistance tester, the second coating layer 103 is removed, and thickness D″ of the electrode plate and film resistance R′ are measured. The second coating layer 103 has a thickness of D, and therefore, resistance R2 of the second coating layer 103 satisfies R2=(R′−R″)/(D′−D″)*D. In a similar test process, to measure the resistance of the first coating layer 102, the entire second coating layer 103 and part of the first coating layer 102 need to be removed, resistance and thickness d′ of the remaining part are measured, and film resistance R1 of the first coating layer 102 having a thickness of d satisfies R1=r′/d′*d. The second test method is to carry out electrochemical impedance spectroscopy (EIS) measurement on an assembled button cell to obtain impedance Rs at the first intersection of the electrochemical impedance spectroscopy and a real axis for the foregoing impedance comparison. The test process is similar to that of the first method, and the only difference is that in the first method, measurement is directly performed on the electrode plate, while in the second method, EIS measurement is performed on a button cell assembled from the electrode plates.

The resistance per unit thickness of the first coating layer 102 and the second coating layer 103 can be adjusted by adjusting types of materials in the first coating layer 102 and the second coating layer 103 and a ratio of various materials. Compared with an electrode plate having no first coating layer 102, use of the first coating layer 102 whose resistance per unit thickness is greater than that of the second coating layer 103, for example, 1.1≤R1/(R2*d/D), improves safety performance of the electrochemical apparatus. This also avoids using an excessively thick first coating layer 102 to increase overall impedance of the electrode plate 10, thereby minimizing an adverse effect on energy density of the electrochemical apparatus. In addition, a value of R1/(R2*d/D) should not be excessively large. When the value of R1/(R2*d/D) is excessively large, electrical performance and rate performance of the electrochemical apparatus are adversely affected.

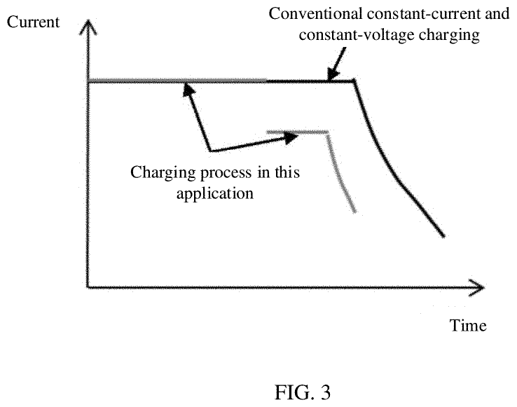

With the first coating layer 102 added, overall impedance of the electrochemical apparatus is increased, but charging performance of the second coating layer 103 is not affected greatly. In this application, a charging method different from a conventional charging method (constant-current charging first, then constant-voltage charging) is used, which can effectively improve a charging speed of the electrochemical apparatus. FIG. 2 and FIG. 3 illustrate a difference between a charging process in this application and conventional constant-current and constant-voltage charging processes. Specifically, in this application, during charging, the electrochemical apparatus is constant-current charged to a first voltage with a first current, constant-current charged to a second voltage higher than the first voltage with a second current lower than the first current, and then constant-voltage charged to a cut-off current. Constant-current charging to the first voltage with the first current is consistent with that in the conventional charging method. However, in this application, the electrochemical apparatus is then constant-current charged to the second voltage higher than the first voltage with the second current lower than the first current, and is constant-voltage charged at the second voltage higher than the first voltage, which can greatly improve the charging speed and reduce charging time.

In some embodiments, thickness d of the first coating layer 102 is greater than 0.5 μm and less than 8 μm. If the thickness d of the first coating layer 102 is excessively small, the first coating layer 102 only has a limited improvement effect on safety performance of the electrochemical apparatus. If the thickness d of the first coating layer 102 is excessively large, energy density and rate performance of the electrochemical apparatus may be adversely affected.

In some embodiments, thickness D of the second coating layer 103 is greater than 20 μm and less than 200 μm. If the thickness D of the second coating layer 103 is excessively small, this is not conducive to improvement of the energy density of the electrochemical apparatus. If the thickness D of the second coating layer 103 is excessively large, this leads to a relatively long migration path of lithium ions on the second coating layer 103 close to the current collector 101, which is not conducive to improvement of the rate performance of the electrochemical apparatus.

In some embodiments, the electrode plate 10 is a positive electrode plate, and the first coating layer 102 includes a first binder and at least one of conductive carbon, ceramic, or a second active material, where a conductivity of the second active material is lower than a conductivity of the first active material. The conductive carbon makes the first coating layer 102 conductive. The ceramic helps improve structural strength of the first coating layer 102. The second active material in the first coating layer 102 helps increase the energy density of the electrochemical apparatus. The first binder in the first coating layer 102 allows various materials in the first coating layer 102 to be bonded together. In addition, the a conductivity of the second active material is set to be lower than the a conductivity of the first active material, allowing the first coating layer 102 to have a resistance per unit thickness greater than that of the second coating layer 103.

In some embodiments, when the first coating layer 102 includes the second active material, a mass percentage of the first binder in the first coating layer 102 ranges from 1% to 10%. When the first coating layer 102 includes the second active material, to exert a gram capacity of the second active material, the mass percentage of the first binder in the first coating layer 102 is relatively low. This is because an excessively large mass percentage of the first binder does not facilitate deintercalation and intercalation of lithium ions in the second active material. Certainly, the mass percentage of the first binder should not be excessively low; otherwise, binding of the first coating layer 102 is affected, leading to a risk of film stripping. In some embodiments, when the first coating layer 102 does not include the second active material, a mass percentage of the first binder in the first coating layer 102 ranges from 30% to 80%. If the mass percentage of the first binder in the first coating layer 102 is greater than 30%, binding force of the first coating layer 102 can be improved, thereby preventing film stripping. Certainly, an excessively large percentage of the first binder may deteriorate electrical performance of the first coating layer 102. In some embodiments, when the mass percentage of the first binder in the first coating layer 102 ranges from 40% to 60%, both good binding performance and electrical performance of the first coating layer 102 can be achieved. In some embodiments, the first binder includes at least one of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, or polyvinyl alcohol. In some embodiments, the conductive carbon includes at least one of conductive carbon black, carbon nanotube, conductive graphite, graphene, acetylene black, or carbon nanofiber.

In some embodiments, when the electrode plate 10 is a positive electrode plate, the first active material may include at least one of lithium cobalt oxide, lithium nickel cobalt manganate, lithium nickel cobalt aluminate, or lithium manganate oxide. In some embodiments, the second active material may include lithium iron phosphate. In some embodiments, the second coating layer 103 may further include a conductive agent and a binder, where the conductive agent in the second coating layer 103 may include at least one of conductive carbon black, Ketjen black, laminated graphite, graphene, carbon nanotube, or carbon fiber; and the binder in the second coating layer 103 may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the first active material to the conductive agent and to the binder in the second coating layer 103 may be (80-99):(0.1-10):(0.1-10). It should be understood that the foregoing description is merely an example, and any other appropriate material, thickness, and mass ratio may be used for the second coating layer 103. In some embodiments, the first coating layer 102 may include a conductive agent (for example, conductive carbon), and a mass percentage of the conductive agent in the first coating layer 102 ranges from 20% to 70%. In some embodiments, a current collector of the positive electrode plate may be Al foil, or certainly may be another current collector commonly used in the art. In some embodiments, thickness of the current collector of the positive electrode plate may range from 1 μm to 50 μm.

In some embodiments, the electrode plate 10 is a negative electrode plate, and the first coating layer 102 includes a second binder and at least one of conductive carbon or ceramic. The conductive carbon helps improve electrical a conductivity of the first coating layer 102. The ceramic helps improve structural strength of the first coating layer 102. The second binder in the first coating layer 102 allows various materials in the first coating layer 102 to be bonded together. In some embodiments, a mass percentage of the second binder in the first coating layer 102 ranges from 30% to 80%. If the mass percentage of the second binder in the first coating layer 102 is greater than 30%, binding force of the first coating layer 102 can be improved, thereby preventing film stripping. Certainly, an excessively large percentage of the second binder may deteriorate electrical performance of the first coating layer 102. In some embodiments, when the mass percentage of the second binder in the first coating layer 102 ranges from 40% to 60%, both good binding performance and electrical performance of the first coating layer 102 can be achieved. In some embodiments, the second binder includes at least one of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, or polyvinyl alcohol. In some embodiments, the conductive carbon includes at least one of conductive carbon black, carbon nanotube, conductive graphite, graphene, acetylene black, or carbon nanofiber.

In some embodiments, when the electrode plate 10 is a negative electrode plate, the first active material may include at least one of graphite, hard carbon, silicon, silicon monoxide, or silicone. In some embodiments, the second coating layer 103 may further include a conductive agent and a binder, where the conductive agent in the second coating layer 103 may include at least one of conductive carbon black, Ketjen black, laminated graphite, graphene, carbon nanotube, or carbon fiber; and the binder in the second coating layer 103 may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the first active material to the conductive agent and to the binder in the second coating layer 103 may be (80-99):(0.1-10):(0.1-10). It should be understood that the foregoing description is merely an example, and any other appropriate material, thickness, and mass ratio may be used for the second coating layer 103. In some embodiments, the first coating layer 102 may include the conductive agent (for example, conductive carbon) and a second binder, and a mass percentage of the conductive agent in the first coating layer 102 may range from 20% to 70%. In some embodiments, the current collector of the negative electrode plate may be at least one of copper foil, nickel foil, or carbon-based current collector. In some embodiments, thickness of the current collector of the negative electrode plate may range from 1 μm to 50 μm.

In some embodiments, the electrochemical apparatus may further include a separator provided between the positive electrode plate and the negative electrode plate. In some embodiments, the separator includes at least one of polyethylene, polypropylene, polyvinylidene fluoride, polyethylene terephthalate, polyimide, or aramid. For example, polyethylene is selected from at least one of high-density polyethylene, low-density polyethylene, or ultra-high molecular weight polyethylene. Especially, polyethylene and polypropylene have a good effect on preventing short circuits, and can improve stability of a battery through a shutdown effect. In some embodiments, thickness of the separator ranges from approximately 5 μm to 50 μm.

In some embodiments, a surface of the separator may further include a porous layer. The porous layer is provided on at least one surface of the separator and includes inorganic particles and a binder, where the inorganic particles are selected from at least one of aluminum oxide (Al₂O₃), silicon dioxide (SiO₂), magnesium oxide (MgO), titanium oxide (TiO₂), hafnium dioxide (HfO₂), stannic oxide (SnO₂), cerium dioxide (CeO₂), nickel oxide (NiO), zinc oxide (ZnO), calcium oxide (CaO), zirconium dioxide (ZrO₂), yttrium oxide (Y₂O₃), silicon carbide (SiC), boehmite, aluminum hydroxide, magnesium hydroxide, calcium hydroxide, or barium sulfate. In some embodiments, a pore of the separator has a diameter ranging from approximately 0.01 μm to 1 μm. The binder of the porous layer is selected from at least one of polyvinylidene fluoride, vinylidene fluoride-hexafluoropropylene copolymer, polyamide, polyacrylonitrile, polyacrylic acid ester, polyacrylic acid, polyacrylate, sodium carboxymethylcellulose, polyvinylpyrrolidone, polyvinyl ether, polymethyl methacrylate, polytetrafluoroethylene, or polyhexafluoropropylene. The porous layer on the surface of the separator can improve heat resistance, oxidation resistance, and electrolyte infiltration performance of the separator, and enhance binding between the separator and the electrode plate.

In some embodiments, the electrochemical apparatus includes a lithium-ion battery. However, this application is not limited thereto. In some embodiments, the electrochemical apparatus may further include an electrolyte. The electrolyte may be one or more of gel electrolyte, solid electrolyte, and liquid electrolyte, and the liquid electrolyte includes a lithium salt and a non-aqueous solvent. The lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoro(oxalate)borate. For example, LiPF₆ is selected as the lithium salt because it has a high ionic conductivity and can improve cycling performance.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is diethyl carbonate (DEC), dimethyl carbonate (DMC), dipropyl carbonate (DPC), methyl propyl carbonate (MPC), ethyl propyl carbonate (EPC), methyl ethyl carbonate (MEC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

In some embodiments of this application, a lithium-ion battery is used as an example. A positive electrode plate, a separator, and a negative electrode plate are wound or stacked in sequence to form an electrode assembly, and the electrode assembly is then packaged, for example, in an aluminum-plastic film, followed by injection of an electrolyte, formation, and packaging, so that the lithium-ion battery is prepared.

In some embodiments, the first voltage is a voltage when a state of charge of the electrochemical apparatus is 100%, a difference between the second voltage and the first voltage is less than or equal to 500 mV, and a ratio of the second current to the first current is greater than 0.5 and less than 1. As described above, in this application, the electrochemical apparatus is first charged to the first voltage by using the conventional constant-current charging method, where the first voltage is a voltage when the state of charge of the electrochemical apparatus is 100%. In some embodiments, the second voltage is higher than the first voltage, but cannot be excessively high; this is because the excessively high second voltage easily causes decomposition of the electrolyte in the electrochemical apparatus. When the difference between the second voltage and the first voltage is less than or equal to 500 mV, decomposition of the electrolyte can be better suppressed, and fast charging can also be implemented. In some embodiments, the difference between the second voltage and the first voltage is less than or equal to 100 mV. In this case, stability of the electrolyte can be better ensured in the charging process. In some embodiments, a larger first current better facilitates fast charging. However, an excessively large current is likely to cause lithium precipitation on a surface of the negative electrode plate. In some embodiments, an optimal first current can be determined using the following method: The electrochemical apparatus is first discharged to a fully discharged state, a specific temperature (for example, 25° C.) is set, the electrochemical apparatus is conventionally charged (constant current+constant voltage) at different rates such as 1 C, 1.1 C, 1.2 C, . . . , and so on based on designs, and the charged electrochemical apparatus is then fully discharged at 0.2 C. After five such cycles, the fully charged electrochemical apparatus is disassembled, so as to check whether lithium precipitation occurs at the negative electrode plate. A maximum current without lithium precipitation (no white spots on the surface of the negative electrode plate) can be determined as the first current. In some embodiments, as described above, the second current is less than the first current, but the ratio of the second current to the first current is set to be greater than 0.5. This is because an excessively small ratio of the second current to the first current causes an excessively small second current and further affects fast charging.

In some embodiments, a cut-off current is greater than 0.1 C and less than 0.6 C. If the cut-off current is excessively small, charging time is excessively long, but charging capacity does not change greatly; if the cut-off current is excessively large, charging capacity is damaged, leaving the electrochemical apparatus at an incompletely charged state. The cut-off current is usually greater than a cut-off current in the conventional charging method, which can reduce the charging time and can also ensure the charging capacity.

An embodiment of this application further provides an electronic apparatus including the foregoing electrochemical apparatus. The electronic apparatus in this embodiment of this application is not particularly limited, and may be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, a lithium-ion capacitor, and the like.

Some specific examples and comparative examples are listed below to better illustrate this application. A lithium-ion battery is used as an example, and a positive electrode plate using the foregoing electrode plate structure is used as an example.

### Example 1

Preparation of positive electrode plate: A binder polyvinylidene fluoride (PVDF), conductive carbon black, and iron phosphate were dissolved in an N-methylpyrrolidone (NMP) solution at a ratio of 3:96:1 to form a first coating layer slurry. Aluminum foil was used as a positive electrode current collector, and the first coating layer slurry was applied on the current collector with a coating width of 80 mm and a thickness of 2 μm. A positive electrode active material lithium cobalt oxide, conductive carbon black, and a binder polyvinylidene fluoride (PVDF) were dissolved in an N-methylpyrrolidone (NMP) solution at a weight ratio of 97.6:1.1:1.3 to form a second coating layer slurry. The second coating layer slurry was applied on the first coating layer with a coating thickness of 50 μm. Width of the electrode plate was 80 mm After drying, cold pressing, and slitting, the positive electrode plate was obtained.

Preparation of negative electrode plate: A negative electrode active material artificial graphite, conductive carbon, and a binder styrene-butadiene rubber were dissolved in deionized water at a weight ratio of 97.5:0.5:2 to form a negative electrode slurry. Copper foil was used as a negative electrode current collector, and the negative electrode slurry was applied on the negative electrode current collector with a coating thickness of 60 μm. Width of the electrode plate was 82 mm After drying, cold pressing, and slitting, the negative electrode plate was obtained.

Preparation of separator: Polyethylene (PE) with a thickness of 8 μm was used as a separator matrix; two sides of the separator matrix were each coated with a 2 μm alumina ceramic layer, and finally, the two sides coated with the ceramic layer were each coated with 2.5 mg/cm² of binder polyvinylidene fluoride (PVDF), and dried.

Preparation of electrolyte: Under an atmosphere with a water content less than 10 ppm, lithium hexafluorophosphate and a non-aqueous organic solvent (a weight ratio of ethylene carbonate (EC) to propylene carbonate (PC) to polypropylene (PP) and to diethyl carbonate (DEC)=1:1:1:1) were prepared into a basic electrolyte, where concentration of LiPF₆ was 1.15 mol/L.

Preparation of lithium-ion battery: The positive electrode plate, the separator, and the negative electrode plate were stacked in sequence, so that the separator was provided between the positive electrode and the negative electrode for separation, and an electrode assembly was obtained through winding. The electrode assembly was put in an outer package aluminum-plastic film, and was dehydrated at 80° C. Then, the foregoing electrolyte was injected and packaging was performed, followed by processes such as formation, degassing, and trimming to obtain a lithium-ion battery.

For other examples and comparative examples, parameters were changed based on steps in Example 1. Specific changed parameters are described below.

In Comparative Example 1, the first coating layer was not applied. In Comparative Examples 2 and 3 and Examples 2 and 3, a value of R1/(R2*d/D) was different from that in Example 1. In the examples, the value of R1/(R2*d/D) could be changed by changing content of binder in the coating layer. In Examples 4 to 7, thickness of the first coating layer was different from that in Example 1.

The following describes methods for testing various parameters in this application.

Nail Penetration Test Pass Rate:

A lithium-ion battery was put in a 25° C. thermostat and left standing for 30 minutes, so that the lithium-ion battery reached constant temperature. The lithium-ion battery that had reached constant temperature was charged at a constant current of 0.5 C to a cut-off voltage of the battery, and then charged constantly at the cut-off voltage until a current reached 0.025 C. The fully charged lithium-ion battery was transferred to a nail penetration tester, test environment temperature was maintained at 25±2° C., and a steel nail with a diameter of 4 mm was driven through the center of the lithium-ion battery at a constant speed of 30 mm/s, and was remained in the battery for 300 s. If the lithium-ion battery did not catch fire or explode, it passed the test. For each example or comparative example, 20 lithium-ion batteries were prepared and tested each time, and the number of lithium-ion batteries that passed the nail penetration test was used as an index for evaluating safety performance of the lithium-ion battery.

Lithium Precipitation Window Test:

The electrochemical apparatus was first discharged to a fully discharged state, a specific temperature (for example, 25° C.) was then set, and the electrochemical apparatus was conventionally charged (constant current+constant voltage) at different rates such as 1 C, 1.1 C, 1.2 C, . . . , and so on based on designs, that is, charged to the cut-off voltage of the battery at specified rates, then constant-voltage charged to 0.05 C to end charging, and then fully discharged at 0.2 C. Such charge-discharge cycle was repeated for 10 times. Finally, the fully charged electrochemical apparatus was disassembled to check whether lithium precipitation occurred at the negative electrode plate. A maximum current without lithium precipitation (no white spots on the surface of the negative electrode plate) was defined as a maximum rate without lithium precipitation of the battery, that is, a lithium precipitation window.

Charging Time Test in Conventional Method:

A to-be-tested lithium-ion battery was left standing for 30 minutes at 25° C., constant-current charged at xC rate until the voltage reached a rated voltage, and then constant-voltage charged to the cut-off current of 0.05 C, and then the charging was ended. Duration from a moment of starting charging to a moment of stopping charging was calculated as full-charge duration.

Charging Time Test in the Method of this Application:

A to-be-tested lithium-ion battery was left standing for 30 minutes at 25° C., constant-current charged at xC rate until the voltage reached a rated voltage, then the charging rate was lowered, the lithium-ion battery was constant-current charged at (0.8x)C to a specific voltage (such voltage=rated voltage+50 mV), and then constant-voltage charged to the cut-off current of 0.2 C, and the charging was ended. Duration from a moment of starting charging to a moment of stopping charging was calculated as full-charge duration.

Energy Density Test:

Battery energy density: A to-be-tested lithium-ion battery was left standing for 30 minutes at 25° C., constant-current charged at 0.5 C until the voltage reached the rated voltage, and then constant-voltage charged until a charge/discharge rate reached 0.05 C. Then, the charging was ended, and a to-be-tested lithium-ion battery was left standing for 30 minutes. Then the battery was discharged to 3.0 V at 0.2 C, and the to-be-tested lithium-ion battery was left standing for 30 minutes. Finally, a discharge capacity was used as an actual battery capacity C of the battery. Assuming that a length, a width, and a height of the tested lithium-ion battery were L, W, and H respectively and that discharge platform voltage of the battery was V, the energy density of the battery was VED=C×V/(L×W×H).

Table 1 shows various parameters and evaluation results in examples 1 to 7 and comparative examples 1 to 3.

TABLE 1

| | | | | Lithium | Full-charge | Full-charge | |
|---|---|---|---|---|---|---|---|
| | | | | precipitation | duration (min) | duration (min) | Energy |
| | | Thickness (μm) of | Nail penetration | window | in conventional | in method of | density |
| | R1/(R2*d/D) | first coating layer | test pass rate | (25° C.) | method | this application | (Wh/L) |
| Comparative | 0 | 0 | 0/10 P | 1.5 C | 78 | / | 730 |
| Example 1 | | | | | | | |
| Comparative | 0.5 | 2 | 2/10 P | 1.5 C | 78 | 67 | 725 |
| Example 2 | | | | | | | |
| Example 1 | 1.1 | 2 | 8/10 P | 1.7 C | 80 | 68 | 725 |
| Example 2 | 4 | 2 | 10/10 P | 2.0 C | 82 | 72 | 725 |
| Example 3 | 8 | 2 | 10/10 P | 2.0 C | 88 | 75 | 725 |
| Comparative | 10 | 2 | 10/10 P | 2.0 C | 90 | 78 | 725 |
| Example 3 | | | | | | | |
| Example 4 | 4 | 0.5 | 9/10 P | 2.0 C | 82 | 72 | 728 |
| Example 5 | 4 | 4 | 10/10 P | 2.0 C | 82 | 72 | 720 |
| Example 6 | 4 | 8 | 10/10 P | 2.0 C | 82 | 72 | 710 |
| Example 7 | 4 | 10 | 10/10 P | 2.0 C | 82 | 72 | 705 |

According to comparison between examples 1 to 3 and comparative Example 1, when the first coating layer was used and 1.1≤R1/(R2*d/D)≤8, the nail penetration rate of the lithium-ion battery could be improved, and safety performance of the lithium-ion battery could be improved. In addition, the lithium precipitation window of the lithium-ion battery was optimized. When the charging method in this application was used for charging, full-charge duration could be reduced, without greatly changing the energy density of the lithium-ion battery.

According to comparison between examples 1 to 3 and comparative examples 2 and 3, when R1/(R2*d/D) was less than 1.1, the nail penetration test pass rate of the lithium-ion battery was excessively low, that is, the safety performance was rather poor; when R1/(R2*d/D) was greater than 8, full-charge duration of the lithium-ion battery was long, which was not conducive to improving fast-charging performance of the lithium-ion battery.

According to comparison between examples 4 to 7, as the thickness of the first coating layer increased, the energy density of the lithium-ion battery tended to decrease. When the thickness of the first coating layer is greater than or equal to 8 μm, the energy density decreased significantly. In addition, when the thickness of the first coating layer was less than or equal to 0.5 μm, the nail penetration test pass rate of the lithium-ion battery was low, that is, the safety performance slightly deteriorates.

The foregoing descriptions are only preferred examples of this application and explanations of the applied technical principles. Persons skilled in the art should understand that the related scope disclosed in this application is not limited to the technical solutions formed by a specific combination of the foregoing technical characteristics, and should also cover other technical solutions formed by any combination of the foregoing technical characteristics or their equivalent characteristics, for example, a technical solution formed by replacement between the foregoing characteristics and technical characteristics having similar functions disclosed in this application.

1. An electrochemical apparatus, comprising an electrode plate; wherein the electrode plate comprises:
a current collector;
a first coating layer; and
a second coating layer comprising a first active material; wherein,
the first coating layer is provided between the current collector and the second coating layer; and
R2*d/D<R1; wherein,
R1 is a resistance of the first coating layer;
R2 is a resistance of the second coating layer;
d is a thickness of the first coating layer;
D is a thickness of the second coating layer;
R2 and R1 are measured in ohms; and
D and d are measured in microns.

2. The electrochemical apparatus according to claim 1, wherein the electrochemical apparatus is configured to be:
constant-current charged to a first voltage with a first current;
constant-current charged, with a second current lower than the first current, to a second voltage higher than the first voltage; and
constant-voltage charged to a cut-off current.

3. The electrochemical apparatus according to claim 1, wherein 1.1≤R1/(R2*d/D)≤8.

4. The electrochemical apparatus according to claim 1, wherein d is greater than 0.5 μm and less than 8 μm.

5. The electrochemical apparatus according to claim 1, wherein D is greater than 20 μm and less than 200 μm.

6. The electrochemical apparatus according to claim 1, wherein,
the electrode plate is a positive electrode plate; and
the first coating layer comprises a first binder, and at least one of a conductive carbon or a second active material having a conductivity lower than a conductivity of the first active material.

7. The electrochemical apparatus according to claim 6, wherein the electrode plate satisfies at least one of conditions (a) to (d):
(a) the first coating layer comprises the second active material, and a mass percentage of the first binder in the first coating layer ranges from 1% to 10%;
(b) the first coating layer comprises the conductive carbon, and a mass percentage of the first binder in the first coating layer ranges from 30% to 80%;
(c) the first binder comprises at least one selected from the group consisting of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, and polyvinyl alcohol; and
(d) the conductive carbon comprises at least one selected from the group consisting of conductive carbon black, carbon nanotube, conductive graphite, graphene, acetylene black, and carbon nanofiber.

8. The electrochemical apparatus according to claim 1, wherein, the electrode plate is a negative electrode plate; and
the first coating layer comprises a second binder and a conductive carbon.

9. The electrochemical apparatus according to claim 8, wherein the electrode plate satisfies at least one of conditions (a) to (c):
(a) a mass percentage of the second binder in the first coating layer ranges from 30% to 80%;
(b) the second binder comprises at least one selected from the group consisting of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, and polyvinyl alcohol; and
(c) the conductive carbon comprises at least one selected from the group consisting of conductive carbon black, carbon nanotube, conductive graphite, graphene, acetylene black, and carbon nanofiber.

10. The electrochemical apparatus according to claim 1, wherein a difference between the second voltage and the first voltage is less than or equal to 500 mV, and a ratio of the second current to the first current is greater than 0.5 and less than 1.

11. An electronic apparatus, comprising an electrochemical apparatus, the electrochemical apparatus comprising an electrode plate; wherein the electrode plate comprises:
a current collector;
a first coating layer; and
a second coating layer comprising a first active material; wherein,
the first coating layer is provided between the current collector and the second coating layer; and
R2*d/D<R1; wherein,
R1 is a resistance of the first coating layer;
R2 is a resistance of the second coating layer;
d is a thickness of the first coating layer;
D is a thickness of the second coating layer;
R2 and R1 are measured in ohms; and
D and d are measured in microns.

12. The electronic apparatus according to claim 11, wherein the electrochemical apparatus is configured to be:
constant-current charged to a first voltage with a first current;
constant-current charged, with a second current lower than the first current, to a second voltage higher than the first voltage; and
constant-voltage charged to a cut-off current.

13. The electronic apparatus according to claim 11, wherein 1.1≤R1/(R2*d/D)≤8.

14. The electronic apparatus according to claim 11, wherein d is greater than 0.5 μm and less than 8 μm.

15. The electronic apparatus according to claim 11, wherein D is greater than 20 μm and less than 200 μm.

16. The electronic apparatus according to claim 11, wherein,
the electrode plate is a positive electrode plate; and
the first coating layer comprises a first binder, and at least one of a conductive carbon or a second active material having a conductivity lower than a conductivity of the first active material.

17. The electronic apparatus according to claim 16, wherein the electrode plate satisfies at least one of conditions (a) to (d):
(a) the first coating layer comprises the second active material, and a mass percentage of the first binder in the first coating layer ranges from 1% to 10%;
(b) the first coating layer comprises the conductive carbon, and a mass percentage of the first binder in the first coating layer ranges from 30% to 80%;
(c) the first binder comprises at least one selected from the group consisting of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, and polyvinyl alcohol; and
(d) the conductive carbon comprises at least one selected from the group consisting of conductive carbon black, carbon nanotube, conductive graphite, graphene, acetylene black, and carbon nanofiber.

18. The electronic apparatus according to claim 11, wherein,
the electrode plate is a negative electrode plate; and
the first coating layer comprises a second binder and a conductive carbon.

19. The electronic apparatus according to claim 18, wherein the electrode plate satisfies at least one of conditions (a) to (c):
(a) a mass percentage of the second binder in the first coating layer ranges from 30% to 80%;
(b) the second binder comprises at least one selected from the group consisting of polyvinylidene fluoride, vinylidene fluoride-fluorinated olefin copolymer, polyvinylpyrrolidone, polyacrylonitrile, poly(methyl acrylate), polytetrafluoroethylene, sodium carboxymethyl cellulose, styrene-butadiene rubber, polyurethane, fluorinated rubber, and polyvinyl alcohol; and
(c) the conductive carbon comprises at least one selected from the group consisting of conductive carbon black, carbon nanotube, conductive graphite, graphene, acetylene black, and carbon nanofiber.

20. The electronic apparatus according to claim 11, wherein a difference between the second voltage and the first voltage is less than or equal to 500 mV, and a ratio of the second current to the first current is greater than 0.5 and less than 1.
